(19) United States
(12) Patent Application Publication
(10) Pub. No.: US 2019/0105815 A1
(43) Pub. Date: Apr. 11, 2019

(54) Mold For Manufacturing Plastics Parts Comprising An Optimized System For Adjusting The Volume Of The Molding Chamber

(71) Applicant: Compagnie Plastic Omnium, Lyon (FR)

(72) Inventor: Thierry Jacquemet, Chatillon La Palud (FR)

(73) Assignee: Compagnie Plastic Omnium, Lyon (FR)

(21) Appl. No.: 16/064,831

(22) PCT Filed: Dec. 15, 2016
(86) PCT No.: PCT/FR2016/053461

§ 371 Date: Nov. 19, 2018

(30) Foreign Application Priority Data
Dec. 21, 2015 (FR) 1562968

(51) Int. Cl. B29C 43/58; B29C 43/36

(52) U.S. Cl. CPC B29C 43/58; B29C 2043/3294; B29C 43/36

(57) ABSTRACT

The invention relates to a mold for manufacturing plastics parts, including a first element and a second element, the two elements defining a volume of a molding chamber in the closed position of the mold. At least one of the elements is provided with a system for adjusting the volume of the molding chamber. The system includes a movable block and a mechanical movement system capable of moving the movable block in a given direction, in a direction that reduces a volume of the molding chamber and/or in an opposite direction for increasing a volume of the molding chamber. The invention also relates to a method of compression molding, to a method of expansion molding and to a method of compression and expansion molding.

### FIELD OF THE INVENTION

This invention relates to the technical field of manufacturing plastic parts, in particular motor vehicle bodywork parts, using a method of compression and/or expansion molding.

### BACKGROUND OF THE INVENTION

To manufacture plastic parts, preferably thermoplastic (TP) parts, it is known to use a method of molding by injection-compression and/or a method of molding by injection-expansion. Such a method uses molding equipment comprising:
a mold provided with a movable element and a fixed element, the two elements, typically made of steel, forming a molding chamber in the closed position of the mold;
a press, generally hydraulic or pneumatic of “cylinder” type, is used to move the movable element towards the fixed element.

Generally, molten plastic material is injected into the molding chamber once the mold is closed. The injected material is compressed during cooling. The reduction in volume of the injected material is accompanied by a reduction in the volume of the molding chamber as the movable element is moved towards the fixed element by the press. In another case, the injected material is of expandable type. It expands in the molding chamber which increases in volume as the movable element is moved away from the fixed element by the press.

It is also known to use a method of compression molding to manufacture plastic parts, in particular thermosetting (TD) parts.

Traditionally, at least one sheet of plastic material, typically sheet molding compound (SMC) consisting of thermosetting resin, reinforcement fibres, and often fillers and/or catalyst (hardener) can be placed in the mold. Pressure is then applied to the sheet of plastic material by reducing the volume of the molding chamber by means of the press so that the sheet takes the shape of the inner walls of the mold.

The presses currently used are powerful presses with high tonnage, i.e. having a very high closing force. Traditionally, the presses have a closing force of between 500 and 2000 tonnes. Since the movement of the movable element of the mold is controlled by the press, the variation in volume of the molding chamber therefore depends on the closing force of the press and the type of material injected. Some plastic materials, in fact, require a high pressure (greater than 30 bars) to make the material flow into the molding cavity, polymerise the material, etc. For the plastic materials generally used, these powerful presses induce a variation in volume or a “high” pitch for adjusting the volume of the molding chamber at each activation.

Such variation in volume is advantageous in certain situations, for example when the plastic material undergoes a rapid variation in volume or to obtain a high force on the surface of the plastic material. However, it can be restricting if it is desired to control the variation in volume of the molding chamber more precisely, i.e. to obtain a smaller adjustment pitch, corresponding to a press closing force of less than 500 tonnes. However, it is difficult to precisely slave the press compression cylinders to reach such values.

In addition, even presses that can operate up to about 500 tonnes do not produce satisfactory results. Significant variations in force are observed around the nominal point of 500 tonnes, in particular at the start of the molding cycle. As a result, large pressure variations (in particular peaks) occur within the plastic material at the start of compression or expansion, as the pressure increases or decreases. These peaks may impair the quality of the part. Due to these pressure peaks, it is impossible to guarantee a homogeneous pressure during molding.

### SUMMARY OF THE INVENTION

The invention aims to overcome these disadvantages and allow more precise control over the variation in volume of the molding chamber, i.e. a smaller adjustment pitch, while ensuring the stability of the variation in volume. Thus, the invention relates in particular to a mold for manufacturing plastic parts, comprising a first element and a second element, the two elements defining a volume of a molding chamber in the closed position of the mold. At least one of the elements is provided with a system for adjusting the volume of the molding chamber, said system comprises a movable block and a mechanical movement system capable of moving the movable block in a given direction, in a direction that reduces a volume of the molding chamber and/or in an opposite direction for increasing a volume of the molding chamber.

Since the movement system is a mechanical system, it can be used to move the movable block in small steps and produce a smaller adjustment pitch, and therefore control more precisely the variation in volume, and therefore pressure, of the molding chamber. This provides a more satisfactory way of accompanying the variation in volume of material added and of producing parts with better quality and with fewer defects. The adjustment system is therefore advantageously used for fragile materials or small parts.

During molding by injection-compression or by compression, the system for adjusting the volume of the molding chamber within one of the elements (fixed or movable) of the mold can be used to vary the volume of the molding chamber at a given time, and to apply a molding pressure to a surface greater than that of the material added in the mold before compression, so as not to start compressing the material when the mold is closed, and to prevent the implementation parameters from impairing the final properties of the material of the part produced.

This system whose power is less than that of the press also provides a way, by progressively reducing the volume of the molding chamber, of guaranteeing a more constant molding pressure, in particular with no overload peaks.

This system for adjusting the volume of the molding chamber also allows the plastic material to expand substantially continuously and without sudden variations in volume, which favours progressive shaping of the plastic material by conforming to the shape of the molding chamber.

The inner molding surface of the movable block is generally the same size as the molding surface of the part with which it is in contact. In some situations, for example in a method of compression molding, a movable block having a smaller area of contact with the part can be used to produce a local variation in volume of the molding chamber. This can be used to specify the pressure at particular locations, for example depending on the shape of the part to be molded.

The mold may further comprise one or more of the following characteristics, taken alone or in combination.

The mechanical movement system comprises at least one screw-nut system consisting of a screw element and a nut element, one of the elements being attached to the movable block, a gear system mechanically cooperating with the one or more screw-nut systems and at least one driving source connected to the gear system. The term “nut element” refers to any element which acts as a nut in a screw-nut system. It may be an independent part traditionally called a “nut” or be a part of another element which comprises a thread acting as a nut. Similarly, the term “screw element” refers to any element which acts as a screw in a screw-nut system.

The screw-nut system cooperating with the gear system makes it possible to control the movement of the movable block more easily and more precisely. It operates by a traditional screw-nut arrangement and does not require a complex system. The element attached to the movable block can either be the screw element or the nut element.

If the screw element is attached to the movable block, rotating the nut in one direction by means of the gear system translates the screw element attached to the movable block by means of the thread. This either reduces the volume of the molding chamber or increases it depending on the direction of rotation of the nut. If the nut element is attached to the movable block, rotating the screw element translates the movable block in a direction which reduces or increases the volume of the molding chamber.

In addition, the movement system allows small movements to be made, in order to adjust or specify the pressure applied to the material added. Thus, the system for adjusting the volume of the molding chamber provided with the movement system is adapted to compress and/or expand a wide range of materials or to compress and/or expand locally some areas of the molding surface of the part.

The gear system comprises a pinion and a rack engaged in the pinion. The pinion cooperates with the screw-nut system so as to move the movable block. The term “pinion” refers to any toothed element having a circular cross-section, for example of cylindrical or conical shape, used to transmit power via a mechanism. A “rack” refers to any element complementary to the pinion in the mechanism, generally having the shape of a rod or a bar.

The pinion and the rack are engaged so that moving one moves the other. The driving source allows the rack to be moved directly or indirectly, in particular the rack performs a continuous “to and fro” translational movement. This translational movement makes it possible to rotate the pinion. As a result, the pinion moves the screw-nut system which therefore moves the movable block. All the links are mechanical and require no complex or expensive devices.

The mechanical movement system comprises the same number of screw-nut systems and pinions. Thus, one pinion is associated with one screw-nut system, in other words, the movement of a screw-nut system is generated by the movement of a pinion.

The gear system comprises a series of pinions and a rack, each pinion of the series of pinions cooperating with a screw-nut system, the series of pinions and the rack being engaged so that actuating the one or more driving sources moves the movable block. The series of pinions may be organised in different ways. For example, the pinions are aligned in a row. The driving source can be used to move the rack and the row of pinions which all turn in the same direction. The pinions may also be organised in a circular or substantially circular series arranged with the rack so that moving either one moves the other. A larger number of pinions increases the number of screw-nut systems and therefore the number of thrust points of the movable block. This distributes the stresses applied by the screw-nut systems on the movable block more uniformly and avoids a stress concentration at a single point. In addition, a more balanced thrust force can be obtained over the entire movable block.

The pinions are all the same size. Preferably, they are all identical. This makes them easier to organise and reduces their cost.

The gear system comprises a series of pinions and two racks, each pinion of the series of pinions cooperating with a screw-nut system, the series of pinions and the racks being engaged so that actuating the one or more driving sources moves the movable block. In particular, the two racks are arranged each side of the series of pinions and parallel with one another and with the series of pinions. Translating a rack in one direction, through a rotation of the series of pinions, translates the other rack in the opposite direction. The pinions of the series all rotate synchronously in the same direction. The movement of the pinions can therefore be controlled more precisely and the efficiency and continuity of the movement of the screw-nut improved. Furthermore, the number of contacts between the racks and the screw-nut system is doubled compared with the case of a single rack, which makes it possible to distribute the stresses applied to the teeth more uniformly and reduce their wear.

The gear system comprises two series of pinions and a rack, each pinion of the two series of pinions cooperating with a screw-nut system, the two series of pinions and the rack being engaged so that actuating the one or more driving sources moves the movable block. In particular, the two series of pinions are arranged on each side of the rack. A series of pinions may be aligned or circular or be organised in any other way. Translating the rack in one direction rotates the two series of pinions in two opposite directions. The number of pinions has increased further for the above-mentioned advantages.

The gear system comprises several series of pinions and several racks, each pinion (40) of the series of pinions cooperating with a screw-nut system, the series of pinions (40) and the racks (42) being engaged so that actuating the one or more driving sources moves the movable block. In particular, the series of pinions and the racks are arranged alternately. Thus, a series of pinions is adjacent to two racks when it is in the middle of the assembly or one rack when it is at the end. Advantageously, two series of pinions can be adjacent and the pinions/racks are organised according to a “two series of pinions associated with one rack” pattern.

The pinion of the gear system or the one or more series of gears and the nut element of the one or more screw-nut systems form the same mechanical part (40). In this case, the nut element corresponds to a thread in a hole of the pinion into which the screw element is inserted.

The nut element of the one or more screw-nut systems is formed in the movable block. In this case, the nut element corresponds to a thread in a hole of the movable block into which the screw element is inserted.

The one or more driving sources are connected to the one or more racks. Since the racks are engaged in the pinions, a single driving source may be sufficient to move all the mechanical components of the movement system. Preferably, each rack is connected to a driving source in order to control the power and movements more precisely.

The driving source comprises a motor connected to one of the pinions of one of the series. The motor, generally electric, rotates a pinion of one of the series of pinions. The rotating pinion transmits torque to the one or more racks that rotate the other pinions of the one or more series of pinions.

The driving source comprises a pneumatic or hydraulic cylinder.

The mold comprises a sensor for controlling the system for adjusting the volume of the molding chamber, for example a pressure sensor associated or not with a stroke sensor. The pressure sensor is placed in contact with the molding chamber and measures the pressure therein. The pressure sensor is connected to the system for adjusting the volume of the molding chamber and is used to control it according to the pressure in the molding chamber. It can be associated with a stroke sensor carried by the mechanical movement system in order to control its movement more precisely.

a first system for adjusting the volume of the molding chamber located in the first element and a second system for adjusting the volume of the molding chamber located in the second element. The two movable blocks of the two systems for adjusting the volume of the molding chamber may be facing each other, and capable of applying the same pressure on the plastic material, when they are pushed into the molding chamber. The two blocks of the two systems for adjusting the volume of the molding chamber can be facing each other, and capable of simultaneously applying pressure on the plastic material, so as to balance forces on each side of the plastic material in the molding chamber.

the first system for adjusting the volume of the molding chamber and the second system for adjusting the volume of the molding chamber comprise the same movement system. A single movement system is sufficient to move two systems for adjusting the volume of the molding chamber, thereby reducing the space requirement, the equipment requirement and the energy consumed.

The invention also relates to a method of compression molding of plastic parts, using a mold comprising the characteristics described above. Plastic material is added to the mold, then said plastic material is compressed by moving the movable block in the given direction, in a direction that reduces a volume of the molding chamber.

The invention also relates to a method of expansion molding of plastic parts, using a mold described above, into which plastic material is added, and said plastic material is allowed to expand by moving the movable block in the given direction, in a direction that increases a volume of the molding chamber.

The invention also relates to a method of compression molding and expansion molding of plastic parts, using a mold described above, into which plastic material is added one or more times, and comprising the following steps:
said plastic material is compressed by moving the movable block in the given direction, in a direction that reduces a volume of the molding chamber,
said plastic material is allowed to expand by moving the movable block in an opposite direction that increases a volume of the molding chamber.

### BRIEF DESCRIPTION OF THE DRAWINGS

The invention will be better understood on reading the accompanying figures, which are given solely by way of example and not limiting in any way, in which:

FIG. 1a is a schematic longitudinal cross-sectional view of a mold according to a first embodiment.

FIG. 1b is a schematic longitudinal cross-sectional view of the mechanical movement system of the mold of FIG. 1a.

FIG. 2a is a view similar to FIG. 1a, the mold being in compression phase.

FIG. 2b is a view similar to FIG. 1b, the mold being in compression phase.

FIG. 3a is a view similar to FIG. 1a, the mold being in expansion phase.

FIG. 3b is a view similar to FIG. 1b, the mold being in expansion phase.

FIG. 4 is a schematic longitudinal cross-sectional view of the mechanical movement system of a mold according to a second embodiment.

FIG. 5 is a schematic longitudinal cross-sectional view of the mechanical movement system of a mold according to a third embodiment.

FIG. 6 is a schematic longitudinal cross-sectional view of the mechanical movement system of a mold according to a fourth embodiment.

FIG. 7 is a schematic longitudinal cross-sectional view of the mechanical movement system of a mold according to a fifth embodiment.

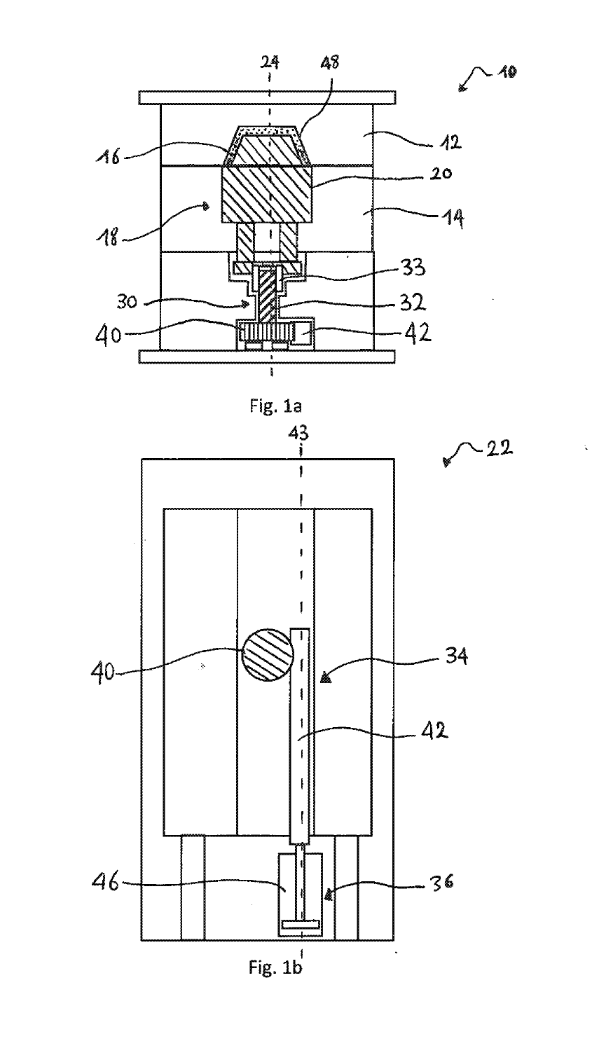

A mold 10 for manufacturing plastic parts, comprises a first element 12, for example the die, and a second element 14, for example the punch. The two elements 12 and 14 define a volume of a molding chamber 16 in the closed position of the mold 10. One of the elements is provided with a system 18 for adjusting the volume of the molding chamber 16. On the examples of FIGS. 1 to 7, the system 18 for adjusting the volume of the molding chamber 16 is provided on the second element 14. The system 18 comprises a movable block 20 and a mechanical movement system 22 capable of moving the movable block 20 in a given direction 24. The direction 24 depends on the orientation of the surface to be compressed and/or to be expanded of the part to be molded. In FIGS. 1a, 2a and 3a, the direction 24 is along a vertical axis. The mechanical movement system 22 can move the movable block 24 in a direction 26 of the direction 24, that reduces a volume of the molding chamber 16 and/or in an opposite direction 28 to increase a volume of the molding chamber 16.

### DETAILED DESCRIPTION OF THE INVENTION

We now refer to FIGS. 1a, 1b, 2a, 2b, 3a and 3b which illustrate a first embodiment.

The mechanical movement system 22 comprises a screw-nut system 30 consisting of a screw element 32 and a nut element 33, one of the elements being attached to the movable block 20. The mechanical movement system 22 also comprises a gear system 34 mechanically cooperating with the screw-nut system 30 and at least one driving source 36 moving the gear system 34. In the embodiment of FIGS. 1a, 2a and 3a, the element of the screw-nut system attached to the movable block 20 is the nut 33. Thus, rotating the screw element 32 translates the movable block 20 in a direction that reduces or increases the volume of the molding chamber 16.

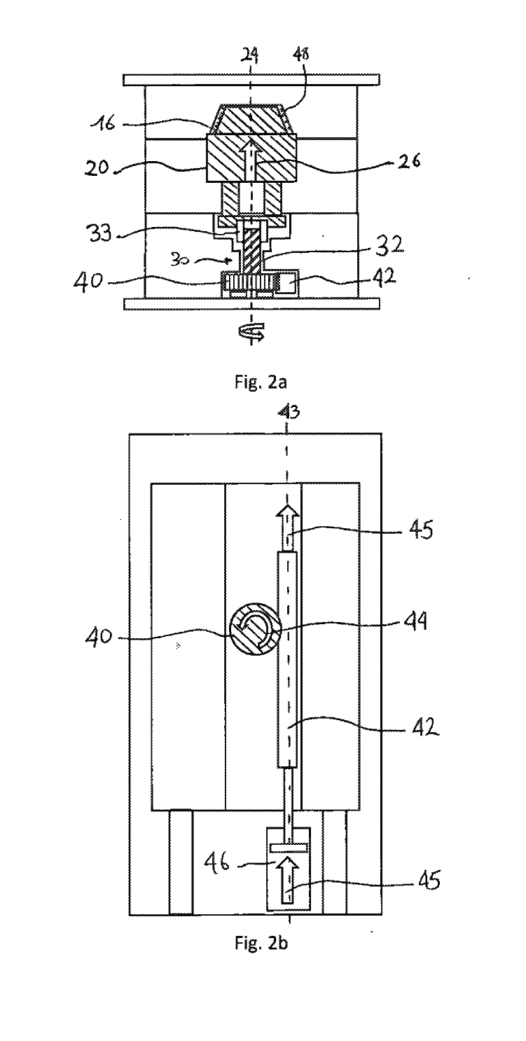

In another embodiment, the screw element 32 is attached to the movable block 20. The screw element comprises two ends. One end is anchored in the movable block 20, attaching it to the screw element 32. The other end is free. The screw element 32 is then inserted in the nut element carried by a pinion 40. The screw-nut system 30 is threaded so that rotating the nut element in one direction translates the screw element 32 in the direction 24 in a corresponding direction. For example, on FIG. 2a, rotating the nut 38 in the anticlockwise direction translates the screw 32 in the direction 26, thereby causing a movement of the movable block 20 in the direction 26.

The gear system 34 comprises the pinion 40 and a rack 42 engaged in the pinion 40. The pinion 40 and the rack 42 comprise teeth oriented so as to form a gear. Thus, rotating the pinion 40 in one direction translates the rack 42 in a direction associated with the direction 43 and vice versa. For example, on FIG. 2b, rotating the pinion 40 in the anticlockwise direction 44 translates the rack 42 in the direction 45, and vice versa in the other direction. Similarly, translating the rack 42 in the direction 45 rotates the pinion 40 in the anticlockwise direction 44.

The pinion 40 cooperates with the screw-nut system 30 so as to move the movable block 20. In the first embodiment, the screw element 32 is attached to the pinion 40. Thus, rotating the pinion 40 rotates the screw element 32 and therefore translates the movable block 20 by means of the nut element 33. For example, on FIGS. 2a and 2b, translating the rack 42 in the direction 44 rotates the pinion 40 in the anticlockwise direction and vice versa for the other direction.

In another embodiment, the nut element is carried by the pinion 40 by means of a thread on a surface of a hole in the pinion 40 into which the screw element 32 is inserted. In other words, the nut element and the pinion 40 form the same mechanical part 40. Thus, translating the rack 24 in the direction 43 rotates the pinion 40, which translates the screw element 32 attached to the movable block 20 in the direction 24, generally perpendicular to the direction 43.

The rack 42 is connected to the driving source 36. The driving source 36 may comprise a hydraulic or pneumatic cylinder 46. Thus, by actuating the cylinder 46 in one direction or another, the rack 42 is translated in an associated direction along the direction 43.

We will now describe the method of compression and/or expansion molding with or without injection of thermosetting material using the mold 10.

Firstly, the plastic material 48 in the form of prepreg sheets and/or injected material are added inside the molding chamber.

In order to compress the material 48, the volume of the molding chamber 16 is reduced by means of the adjustment system 18, as illustrated on FIGS. 2a and 2b. To do this, the driving source 36 is activated in the direction 45, for example by pushing the piston of a cylinder 46, in order to translate the rack 42 of the gear system 34 in the same direction. This rotates the pinion 40 in the anticlockwise direction and therefore also rotates the screw element 32 attached to the pinion 40.

The thread of the nut element 33 associated with that of the screw element 32 allows the nut element 33 to translate in the direction 26 of the direction 24. Since the nut element 33 is attached to the movable block 20, the latter moves in the same direction, i.e. in this case in the direction that reduces the volume of the molding chamber 16. Thus, the movable block 20 compresses the material 48, in particular at the contact surface between the movable block 20 and the material 48.

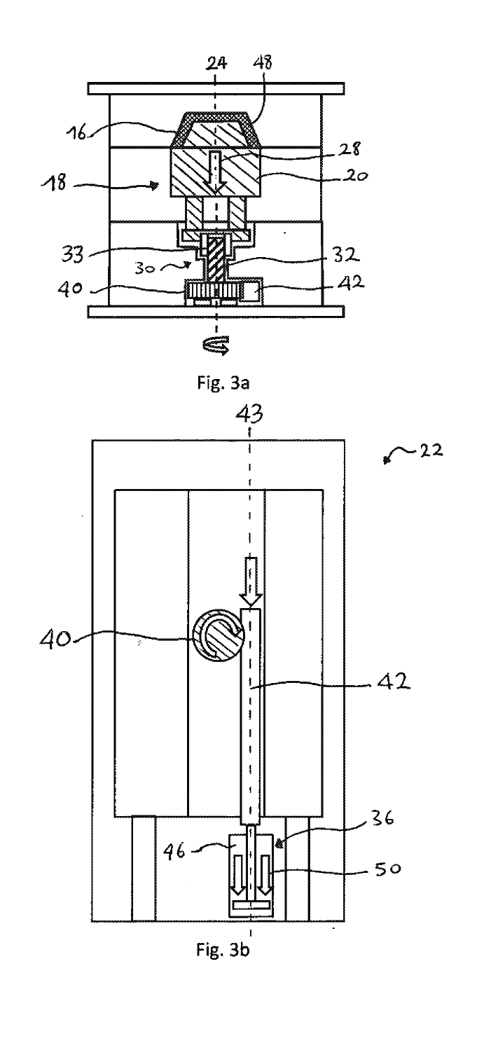

In order to expand the material 48, the volume of the molding chamber 16 is increased by means of the adjustment system 18, as illustrated on FIGS. 3a and 3b. Since the mechanism described above is reversible, by activating the driving source 36 in the direction 50, the block 20 is moved in the direction 28 so as to increase the volume of the molding chamber 16. The driving source 36 is activated in the direction 50 of FIG. 3 for example by pulling a piston of the cylinder 46. The material 48 then expands as the block moves 20.

In the embodiment in which the nut element 33 is carried by the pinion 40 and the screw element 32 is attached to the movable block 20, the method is the same as that described above by applying the operation of the screw-nut system described for this embodiment.

Both the compression and expansion methods can be implemented independently, successively or simultaneously using several adjustment systems 18 located at different positions of the mold 10.

In the remainder of this document, the elements common to the different embodiments are identified by the same numerical references. Only the main differences are described, note that the other elements are similar.

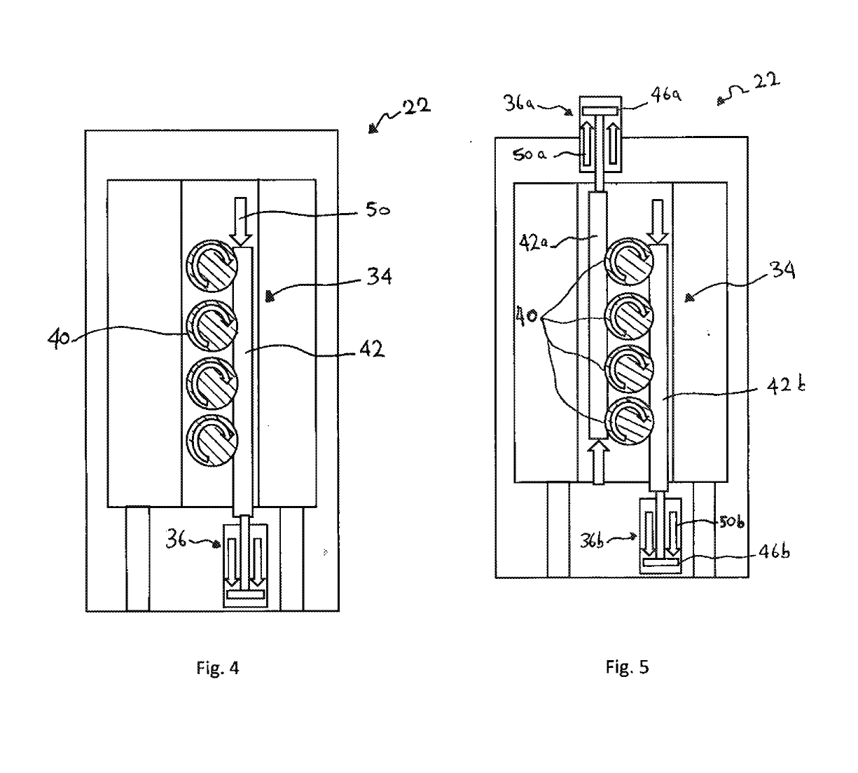

We now refer to FIG. 4 which illustrates a second embodiment.

The gear system 34 comprises a series of pinions 40 and a rack 42. In the example of FIG. 4, the series of pinions 40 is a row of four pinions 40 aligned in the axis of the rack 42. It could also be arranged differently, for example in a circle, the pinions 410 being engaged in the rack 42. Each pinion 40 cooperates with a screw-nut system 30 (not shown on FIGS. 4 to 7). Thus, the number of screw-nut systems 30 corresponds to the number of pinions 40 present. The series of pinions 40 and the rack 42 are engaged so that actuating the driving source 36 moves the movable block 20, in the same way as in the first embodiment. The pinions 40 of the series have teeth arranged so that translating the rack 42 rotates all the pinions 40 simultaneously in the same direction. By using several pinions 40, the stresses are distributed more uniformly on several thrust points on the movable block 20 and a stress concentration is avoided.

The operation of the movement system 22 comprising the gear system 34 according to this second embodiment is similar to that described for the first embodiment. The same applies for the methods of compression and/or expansion molding using the mold provided with this movement system 22.

We now refer to FIG. 5 which illustrates a third embodiment.

The gear system 34 comprises a series of pinions 40 and two racks 42a and 42b, each pinion 40 of the series of pinions cooperating with a screw-nut system 30. The series of pinions 40 and the racks 42a and 42b are engaged so that actuating the driving sources 36a and 36b moves the movable block 20. The two racks 42a and 42b are arranged on each side of the series of pinions 40 which is, in this example, a row of four pinions 40. The driving sources 36a and 36b comprise two cylinders 46a and 46b, respectively connected to the racks 42a and 42b. The two cylinders 46a and 46b are actuated simultaneously in two opposite directions 50a and 50b, thereby translating the two racks 42a and 42b also in opposite directions. The series of pinions 40 engaged in the two racks 42a and 42b is rotated in the same direction.

In an alternative, the driving source 36 comprises only one cylinder, for example the cylinder 46a. Actuating the cylinder 46a translates the rack 42a, thereby rotating the series of pinions 40. The latter series translates the rack 42b.

The operation of the movement system 22 comprising the gear system 34 according to this third embodiment is similar to that described for the first embodiment. The same applies for the methods of compression and/or expansion molding using the mold provided with this movement system 22.

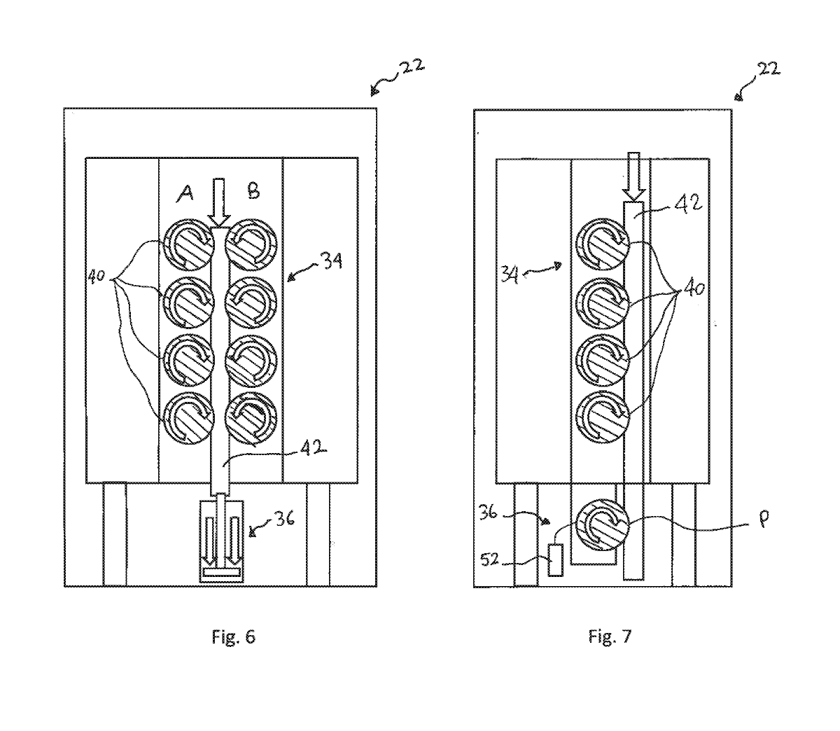

We now refer to FIG. 6 which illustrates a fourth embodiment.

The gear system 34 comprises two series A and B of pinions 40 and a rack 42, each pinion 40 of the two series A and B cooperating with a screw-nut system 30. The two series A and B of pinions 40 and the rack 42 are engaged so that actuating the driving source 36 moves the movable block 20 (not shown on FIGS. 4 to 7). The driving source 36 comprises a cylinder 46 connected to the rack 42. The series A and B of pinions 40 are positioned on each side of the rack 42. The pinions 40 and the rack 42 are engaged by the cooperation of gear teeth, so that translating the rack 42 simultaneously rotates the two series A and B of pinions 40 in opposite directions, for example in the clockwise direction for the series A and in the anticlockwise direction for the series B. The arrangement of the series A and B of pinions 40 distributes the stresses and the driving forces over the entire movable block 20 more uniformly.

The operation of the movement system 22 comprising the gear system 34 according to this fourth embodiment is similar to that described for the first embodiment. The same applies for the methods of compression and/or expansion molding using the mold provided with this movement system 22.

We now refer to FIG. 7 which illustrates a fifth embodiment.

This embodiment is similar to the second embodiment. Its main difference lies in the fact that the driving source 36 comprises a motor 52 connected to one of the pinions P of one of the series. The driving source 36 is in fact no longer connected to the rack 42 but to a pinion P of the series of pinions. Thus, actuating the driving source 36 rotates the pinion P, thereby translating the rack 42 and therefore rotating the other pinions 40 of the series in the same direction.

The driving source 36 according to this fifth embodiment can also be applied to the other embodiments in a similar manner.

The operation of the movement system 22 comprising the gear system 34 according to this fifth embodiment is similar to that described for the first embodiment. The same applies for the methods of compression and/or expansion molding using the mold provided with this movement system 22.

In addition, a motor can also be used instead of the cylinder 46 of the driving source 36 in the preceding embodiments.

In another embodiment, the mold 10 is provided with a first system for adjusting the volume of the molding chamber 16 located in the first element 12 and a second system for adjusting the volume of the molding chamber 16 located in the second element 14. These two adjustment systems may comprise the same movement system 22 according to the embodiments 1 to 5. Thus simultaneously actuating one or more of the driving sources 36 moves the two elements for adjusting the volume of the molding chamber.

The invention is not limited to the embodiments described and other embodiments will be clearly apparent to those skilled in the art. It is in particular possible to combine the various embodiments described, and especially to make a gear system with several pinions and several racks by replicating an embodiment or combining several embodiments.

1. A mold for manufacturing plastic parts, comprising a first element and a second element, the two elements defining a volume of a molding chamber in a closed position of the mold, wherein at least one of the elements is provided with a system for adjusting the volume of the molding chamber, said system comprises a movable block and a mechanical movement system capable of moving the movable block in a given direction that changes a volume of the molding chamber.

2. The mold according to claim 1, wherein the mechanical movement system comprises at least one screw-nut system comprising a screw element and a nut element, the screw elements being attached to the movable block, a gear system mechanically cooperating with said at least one screw-nut system and at least one driving source connected to the gear system.

3. The mold according to claim 2, wherein the gear system comprises a pinion and a rack engaged in the pinion, the pinion cooperating with said at least one screw-nut system so as to move the movable block.

4. The mold according to claim 2, wherein the gear system comprises a series of pinions and a rack, each pinion of the series of pinions cooperating with a screw-nut system, the series of pinions and the rack being engaged so that actuating said at least one driving source moves the movable block.

5. The mold according to claim 2, wherein the gear system comprises a series of pinions and two racks, each pinion of the series of pinions cooperating with a screw-nut system, the series of pinions and the racks being engaged so that actuating said at least one driving source moves the movable block.

6. The mold according to claim 2, wherein the gear system comprises two series of pinions and a rack, each pinion of the two series of pinions cooperating with a screw-nut system, the two series of pinions and the rack being engaged so that actuating said at least one driving source moves the movable block.

7. The mold according to claim 2, wherein the gear system comprises several series of pinions and several racks, each pinion of the series of pinions cooperating with a screw-nut system, the series of pinions and the racks being engaged so that actuating the driving source moves the movable block.

8. The mold according to claim 3, wherein the pinion of the gear system or of the one or more series of pinions and the nut element of the one or more screw-nut systems form the same mechanical part.

9. A mold according to claim 3, wherein the driving source comprises a motor connected to one of the pinions of one of the series of pinions.

10. The mold according to claim 2, wherein the driving source comprises a pneumatic or hydraulic cylinder connected to one of the racks.

11. The mold according to claim 1, comprising a first system for adjusting the volume of the molding chamber located in the first element and a second system for adjusting the volume of the molding chamber located in the second element.

12. The mold according to the preceding claim 11, wherein the first system for adjusting the volume of the molding chamber and the second system for adjusting the volume of the molding chamber comprise the same mechanical movement system.

13. A method of compression molding of plastic parts comprising:
using a mold comprising a first element and a second element, the two elements defining a volume of a molding chamber in a closed position of the mold, wherein at least one of the elements is provided with a system for adjusting the volume of the molding chamber, said system comprises a movable block and a mechanical movement system capable of moving the movable block in a given direction that changes a volume of the molding chamber;
wherein plastic material is added to the mold, then said plastic material is compressed or expanded by moving the movable block in the given direction.

14. The method of claim 13 further comprising, the given direction increasing a volume of the molding chamber to provide expansion molding of plastic parts.

15. The method of claim 13 further comprising;
compression molding and expansion molding plastic parts, using the mold, wherein plastic material is added one or more times, and comprising the following steps:
said plastic material is compressed by moving the movable block such that in this step, the given direction reduces a volume of the molding chamber,
said plastic material is allowed to expand by moving the movable block such that in this step, the given direction increases a volume of the molding chamber.

16. The method of claim 13 further comprising, the given direction reducing a volume of the molding chamber to provide compression molding of plastic parts.
